(19) United States
(12) Patent Application Publication
(10) Pub. No.: US 2012/0298771 A1
(43) Pub. Date: Nov. 29, 2012

(54) AIRLESS SPRAY TIP

(76) Inventors: Daniel R. Johnson, Blaine, MN (US); Charles W. Dawson, Big Lake, MN (US)

(21) Appl. No.: 13/521,696

(22) PCT Filed: Jan. 26, 2011
(86) PCT No.: PCT/US11/22488

§ 371 Date: Jul. 11, 2012

Related U.S. Application Data
(60) Provisional application No. 61/298,775, filed on Jan. 27, 2010.

(51) Int. Cl. B05B 3/02

(52) U.S. Cl. 239/214

(57) ABSTRACT

In airless spray tip assembly 100 shown in FIG. 2, cylinder 112 contains tip 114 and is at one end of dead zone 0 116. Shutoff 118 is comprised of ball 120 and seat 122. The needle seat 122 has been mated to each tip assembly 100 (See FIG. 2). By mating the tip 114 and the seat assembly (shutoff) 118 into one, the seal 124 can be moved out of the ‘dead zone’ 116 thus reducing spit volume and energy storage.

### TECHNICAL FIELD

This application claims the benefit of U.S. application Ser. No. 61/298,775, filed on Jan. 27, 2010 the contents of which are hereby incorporated by reference.

### BACKGROUND ART

Typical airless spray tips are shown in U.S. Pat. Nos. 4,165,836 and 6,702,198, the contents of which are incorporated by reference. In current reversible spray tip applications; it is commonplace to have potential energy stored in o-rings that lie ahead of the mechanical fluid seal that actuates the gun and behind the spray tip. Examples of high potential energy storing materials would be o-rings. They store energy in such a way that when the gun is shutoff, the seals de-energize and spit onto the painter's work.

### DISCLOSURE OF THE INVENTION

It is an object of this invention is to minimize energy storage in an airless spray tip to minimize spit volume. The construction of this tip assembly is different than prior art devices. The needle seat has been mated to each tip assembly. By mating the tip and the seat assembly into one, the seal can be moved out of the ‘dead zone’ thus reducing spit volume. The instant invention eliminates all o-rings ahead of the mechanical fluid shutoff, thus minimizing the spit.

These and other objects and advantages of the invention will appear more fully from the following description made in conjunction with the accompanying drawings wherein like reference characters refer to the same or similar parts throughout the several views.

### BRIEF DESCRIPTION OF DRAWINGS

FIG. 1 shows a prior art tip assembly.

FIG. 2 shows the tip assembly of the instant invention.

### BEST MODE FOR CARRYING OUT THE INVENTION

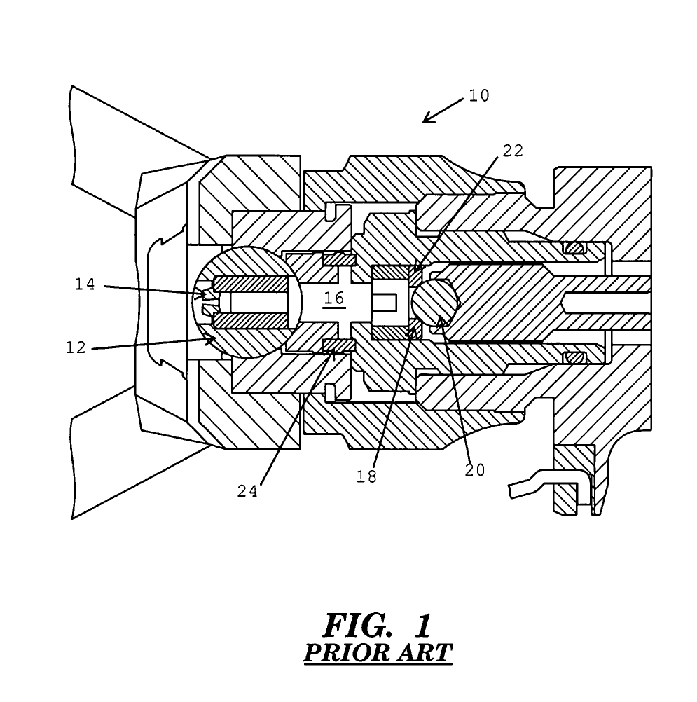

In the prior art reversible tip assemblies 10 such as shown in FIG. 1, cylinder 12 contains a spray tip 14 of a known design. A dead zone 16 is located between tip 14 and the shutoff 18 comprised of ball 20 and seat 22. An o-ring seal 24 is located in the dead zone 16 and can store energy and release same. Seal 24 is compressible when exposed to typical airless spraying pressures, typically 2000-3000 psi. While any material is theoretically compressible, as used herein, the term denotes materials which can be substantially compressed and released when exposed to such pressures. Metals and similar materials in their normal form are not considered compressible.

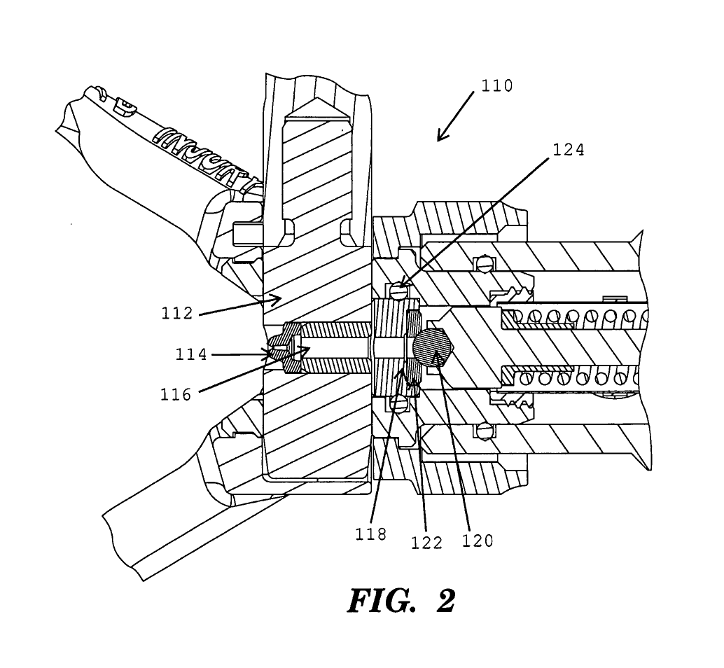

In the instant invention tip assembly 100 shown in FIG. 2, cylinder 112 contains tip 114 and is at one end of dead zone 116. Shutoff 118 is comprised of ball 120 and seat 122. The needle scat 122 has been mated to each tip assembly 100 (See FIG. 2). By mating the tip 114 and the seat assembly (shutoff) 118 into one, the seal 124 can be moved out of the ‘dead zone’ 116 thus reducing spit volume and energy storage.

In current reversible spray tip applications; it is commonplace to have potential energy stored in o-rings that lie ahead of the mechanical fluid seal that actuates the gun and behind the spray tip. Examples of high potential energy storing materials would be o-rings. They store energy in such a way that when the gun is shutoff, the seals de-energize and spit onto the painter's work. The instant invention eliminates all o-rings ahead of the mechanical fluid shutoff, thus minimizing the spit.

It is contemplated that various changes and modifications may be made to the spray tip without departing from the spirit and scope of the invention as defined by the following claims.

1. In a reversible airless spray tip assembly comprising a rotatable cylinder containing a spray tip and a shutoff mechanism with a dead zone between said tip and said shutoff mechanism, the improvement comprising eliminating compressible materials from said dead zone.
